(19) United States
(12) Patent Application Publication
(10) Pub. No.: US 2004/0003501 A1
(43) Pub. Date: Jan. 8, 2004

(54) Scissors

(76) Inventor: Akira Mikami, Osaka (JP)

Correspondence Address: Koda & Androlia, Suite 3850, 2029 Century Park East, Los Angeles, CA, 90067-3024, US

(21) Appl. No.: 10/343,258

(22) PCT Filed: Feb. 7, 2001
(86) PCT No.: PCT/JP01/00867

(51) Int. Cl. B26B 19/00

(52) U.S. Cl. 30/199; 30/254

(57) ABSTRACT

Occupational disorders including pain in hand and stiff shoulders to be caused by using scissors, which are giving rise to problems in the barber and beauty industry, can be lessened or prevented. The scissors are highly versatile to be capable of coping with diversity of cutting techniques. In the scissors, the leg of the movable blade can be divided into the ring side leg portion and the blade side leg portion, and the position of the ring to which the thumb is inserted can be adjusted freely by loosening and fastening the connecting screw depending on the size of the hand and the length of the thumb. Further, the leg of the movable blade is provided with a pair of finger-inserting rings, and the leg of the fixed blade is provided with one such ring. With these total three finger-inserting rings, the scissors can be used in a manner totally different from the usage of the conventional scissors to cope with diversified new cutting techniques.

### TECHNICAL FIELD

The present invention relates to a pair of highly versatile scissors which prevents or lessens occupational disorders occurring mainly in the barber and beauty industry and which can also cope with new cutting techniques.

### BACKGROUND ART

While scissors and razors have conventionally been used widely in the barber and beauty industry, diversified hairstyles are coming out recently, and new cutting techniques are devised one after another. Under such circumstances, it is difficult for the conventional scissors or razors to cope with some of these new techniques. For example, the tapering technique referred to as slide cutting does not damage hair cuticles unlike razor cutting, but a technician is likely to suffer disorders including pain in the root of the thumb and stiff shoulders, since the technician cuts hair with his or her hand gripping the scissors waving widely. In addition, it is supposedly difficult to master this technique.

However, this tapering cutting technique to impart natural dynamics to a haircut is growing into fashion not only in Japan but also all over the world.

Therefore, the present invention provides a novel pair of scissors which lessens fatigue of technicians to prevent such disorders from occurring and which facilitates mastering of new techniques.

### DISCLOSURE OF THE INVENTION

The present invention provides a pair of scissors having a pivot shaft between a point of force and a point of application, in which a leg of a movable blade can be divided at the middle into a blade side leg portion and a ring A,B side leg portion, and they are connected to each other with a loosenable and fastenable connecting screw. In the usage of the scissors like the conventional scissors to open and close the movable blade and a fixed blade by operating the thumb, the thumb can be located at an optimal position by loosening and fastening the connecting screw so that the operation of opening and closing the scissors can be performed smoothly. Thus, the thumb is forced to perform no unnatural movement, so that the present invention is also useful for preventing disorders and lessening fatigue of technicians even if the scissors are used in the conventional cutting technique. Next, in a usage (1) of the scissors suitable for the new cutting techniques referred to as slide cutting and stroke cutting in which a technician waves the scissors widely, the connecting screw is loosened and the index finger and the middle finger are inserted to a ring A and a ring B respectively provided in the leg of the movable blade, while the thumb is inserted to a ring C provided at the end of a leg of the fixed blade. Here, the ring A,B side leg portion makes a free pendular movement about the connecting screw. The rings A and B are moved back and forth slightly with the index finger and the middle finger to cut hair in a slithering manner. While the technician waves the scissors widely, the scissors cause less concentration of fatigue to the root of the thumb unlike the conventional scissors and give less fatigue to the technician.

Further, in another usage (2) of the scissors of the present invention suitable for these new cutting techniques, a technician grips the long leg of the fixed blade by the left or right hand and pushes the ring A or B back and forth with the thumb of the same hand to cut hair in a slithering manner. According to this method, scissors of the same configuration can be used irrespective of dextrality and sinistrality of the user. In addition, one can master new cutting techniques in a short time, since the scissors are very easy to operate. Further, fatigue of technicians can be lessened greatly.

As described above, compared with the conventional type of scissors employed in the barber and beauty industry, the present invention not only enjoys extremely high applicability to new cutting techniques but also is useful for preventing or lessening occupational disorders in technicians, which is now giving rise to problems.

### BRIEF DESCRIPTION OF THE DRAWINGS

FIG. 1 is a plan view;

FIG. 2 illustrates the usage of a pair of scissors similar to that of the conventional scissors;

FIG. 3 shows the usage (1) of the scissors suitable for the new cutting techniques; and

FIG. 4 shows the usage (2) of the scissors suitable for the new cutting techniques.

### BEST MODE FOR CARRYING OUT THE INVENTION

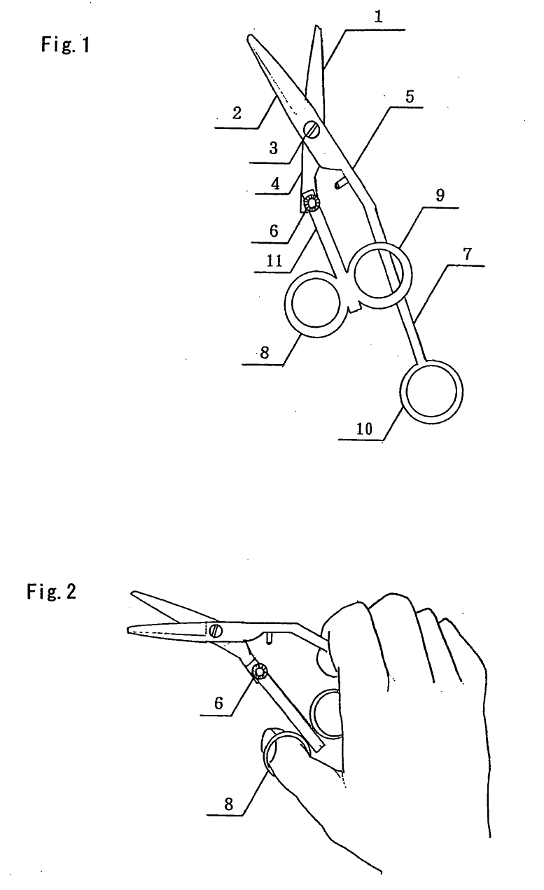

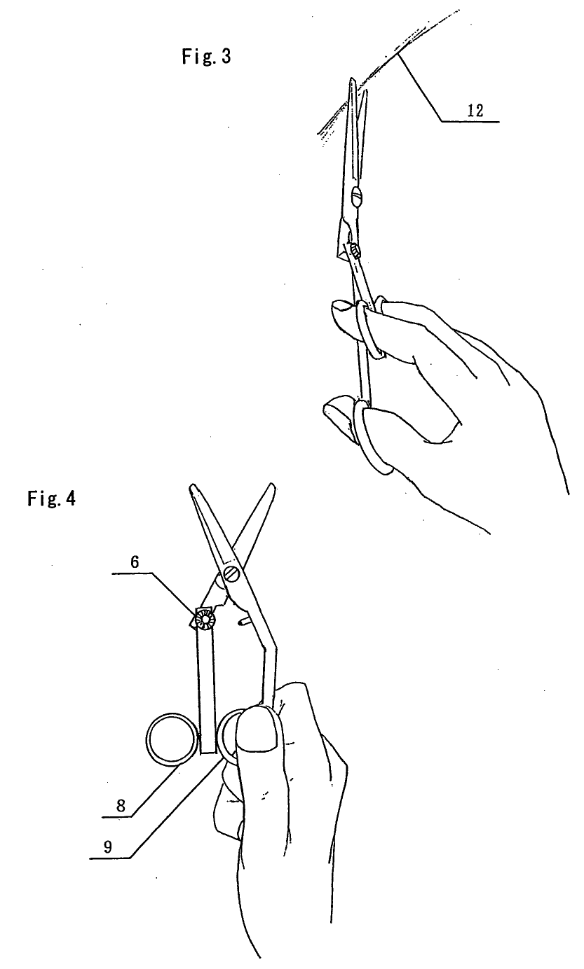

The present invention is described in detail referring to the drawings. FIG. 1 is a plan view of a pair of scissors, and a first aspect of the present invention is that a leg of a movable blade is divided at the middle into a blade side leg portion and a ring A,B side leg portion which are connected to each other with a connecting screw and that the leg of the movable blade is provided with a pair of rings to which rings (sic) are inserted, whereas a leg of the fixed blade is provided with one such ring. A second aspect is that the ring A,B side leg portion is designed to make a pendular movement about the connecting screw. Thus, depending on the usage of the scissors and on the size and shape of a user's hand, the rings A and B can be moved to optimal positions and locked there by fastening them with the connecting screw. A third aspect is that the leg of the fixed blade is much longer than the leg of the movable blade. This is because the leg of the fixed blade is adapted to be gripped by a technician when the scissors are used, which is a unique usage that is never possible with conventional type of scissors. FIG. 2 illustrates the usage of the pair of scissors similar to that of the conventional scissors, wherein the connecting screw is fastened, and the scissors are opened and closed with the thumb being inserted into the ring A or B (the ring A in FIG. 2). FIG. 3 shows the usage (1) suitable for new cutting techniques, wherein the connecting screw is loosened, and the movable blade and the fixed bladed are opened and closed by moving the rings A and B back and forth. A relief angle of about 10° is secured for the ring A,B side leg portion with respect to the fixed blade so that the movable blade and the fixed blade can perform this movement smoothly and that the ring A,B side leg portion can move across over the fixed blade.

FIG. 4 shows the usage (2) suitable for the new cutting techniques, wherein a technician grips the long leg of the fixed-blade with the right hand and holds the ring A or B (the ring B in FIG. 4) with the thumb of the same hand to open and close the movable blade and the fixed blade by moving the thumb back and forth over a stroke of about 10 mm to 20 mm. Here again, the connecting screw is loosened. According to this usage, the scissors can be used irrespective of dextrality and sinistrality of the user.

### INDUSTRIAL APPLICABILITY

It may well be said that the present invention is very useful for preventing or lessening of occupational disorders including pain in hand and stiff shoulders attributable to use of scissors which are giving rise to problems in the barber and beauty industry as well as for mastering new cutting techniques.

The reason is that trends concerned with hair fashion are expected to come and go more and more swiftly in the future, and much more complicated and diversified cutting techniques will be developed with the trend. Further, average age of barbers and hairdressers is becoming higher and the longer the period of using scissors, the higher becomes naturally the incidence of occupational disorders in technicians.

1. A pair of scissors comprising a movable blade and a fixed blade and having a pivot shaft between a point of force and a point of application, wherein a leg of the movable blade only is divided at a middle into a blade side leg portion and a ring A,B side leg portion that are connected to each other with a loosenable and fastenable connecting screw; the ring A,B side leg portion being capable of making a pendular movement within a range of ±150° when the connecting screw is loosened.

2. The pair of scissors according to claim 1, wherein the leg of the movable blade is provided with a pair of rings to which fingers are inserted, and a leg of the fixed blade is provided with one such ring.

3. The pair of scissors according to claim 1, wherein the leg of the fixed blade is bent inward (toward the movable blade side) at an angle within a range of 1° to 50° and is longer than the leg of the movable blade by 20 mm or more so that the leg of the fixed blade can be gripped by the right or left hand.
